(19) United States
(12) Patent Application Publication
(10) Pub. No.: US 2009/0224708 A1
(43) Pub. Date: Sep. 10, 2009

(54) SPLIT BRUSHLESS MOTOR DRIVING CONTROLLER FOR CEILING FAN

(75) Inventors: Chien-Hsun CHEN, Taichung (TW); Chih-Jia Kung, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Rhine Electronics Co., Ltd., Tan-Zi Shiang (TW)

(21) Appl. No.: 12/045,307

(22) Filed: Mar. 10, 2008

(51) Int. Cl. H02P 6/08

(52) U.S. Cl. 318/400.04; 318/400.3

(57) ABSTRACT

A driving controller uses with a ceiling fan, which has a brushless motor. The driving controller including: a microprocessor unit having control programs and ROM units. The ROM units save the departure parameter data of the brushless motor inside. The microprocessor can read a designate departure parameter from the ROM units and loads it into the control programs. A signal receiving unit connects with the microprocessor. A hardware setting unit connects with the microprocessor. A driving circuit connects with the microprocessor and the brushless motor of the ceiling fan. A feedback circuit connects with the microprocessor and the driving circuit. The feedback circuit can detect the amperage or the voltage of the driving circuit and transmits a feedback to the microprocessor. A power input unit connects with the signal receiving unit and a circuit with rectifier and filter function.

### BACKGROUND OF THE INVENTION

1. Field of the Invention

The present invention relates to a motor driving controller for ceiling fan. More particular, to a split brushless motor driving controller for ceiling fan.

2. Description of the Related Art

There are two ways to drive the brushless motor of the ceiling fan correctly in present day. There are some simple instructions hereinafter. The first way is using sensors to detect the correct position of the armature before driving it to rotate. Although this way provides a stable driving control but the ceiling fan needs sensors additionally, and this type of structure causes maintainable problems in sometime. By the reason that the sensors needs to place adjacent the motor and the motor needs to place adjacent the driving controller. All the sensors, the motor and the driving controller will be packed inside the housing of the ceiling fan finally. In case of that the controller or the sensor is breakdown, the whole structures need to detach for maintain. This work is very inconvenience. Moreover, there is the other problem. Because that all the sensors, the motor and driving controller needs to pack together inside the housing, the down rod of the ceiling fan must allow at least three power lines and three to five control lines to go through it, and to reach the basic controlled requirement. This is very inconvenience in manufacture.

The second way is a sensorless way. The driving controller drives the motor by using a back electromotive force or an induced current to estimate the armature position. But, the back electromotive force or the induced current approaches to zero when the motor was very slow or stop. This situation causes the driver controller can not estimate the armature position. In order to prevent this situation, the controller magnetizes the stator at the initiation to make the armature move to a specific position then drives the motor with a cumulative voltage. By the character of stepping motor, the rotative speed of the armature increases too. But, the motor may shake or reverse when the controller magnetized the stator. As a normal user, this situation may give a wrong cognition. They may think the motor is breakdown. This is also a confused problem for a customer.

### SUMMARY OF THE INVENTION

The object of the present invention is to provide a split brushless motor driving controller for ceiling fan, which can drive the brushless motor correctly without sensor or locating the armature, and splits the machinery structures and the control circuits.

To achieve object of the present invention, a driving controller of present invention use the cooperation of the control programs and the departure parameter data in the microprocessor to control the brushless motor of the ceiling fan. The driving controller can drive the motor in correct phase without sensors or locating armature.

### BRIEF DESCRIPTION OF THE DRAWINGS

FIG. 1 is a functional unit chart of the first embodiment of present invention.

FIG. 2 is a functional unit chart of the second embodiment of present invention.

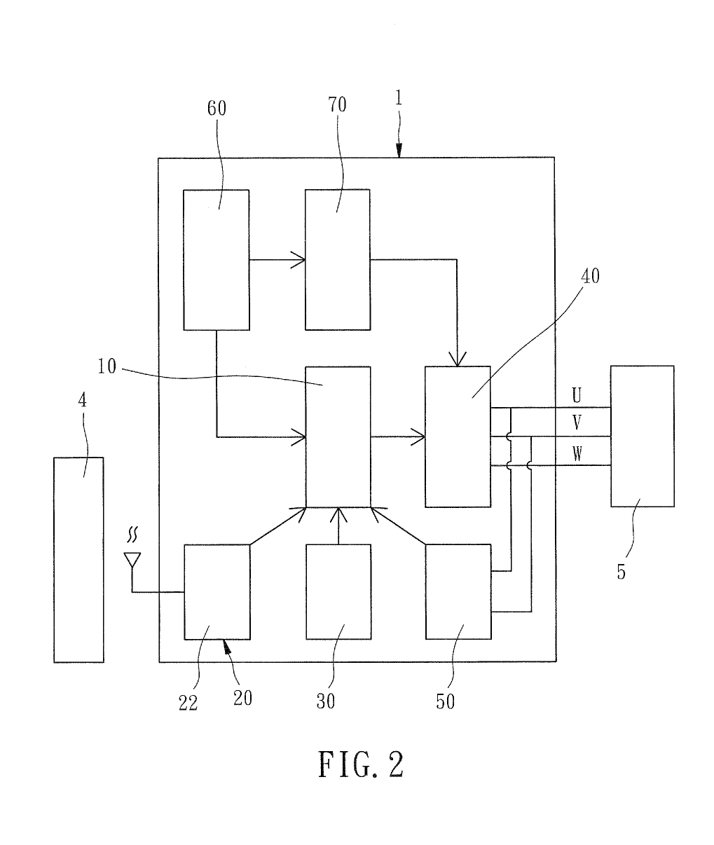

FIG. 3 is a functional unit chart of the third embodiment of present invention.

FIG. 4 is a functional unit chart of the fourth embodiment of present invention.

FIG. 5 is a flow chart of the operating setting process, which shows the setting flow path of the driving controller.

### DETAILED DESCRIPTION OF THE INVENTION

Referring to illustrations, the driving controller uses with a ceiling fan, which has a brushless motor. The driving controller of present invention including:

A microprocessor unit 10, which can control transfer calculate signals, has control programs and ROM units therein. The ROM units save the departure parameter data of the brushless motor inside. The microprocessor can read a designate departure parameter from the ROM units and loads it into the control programs.

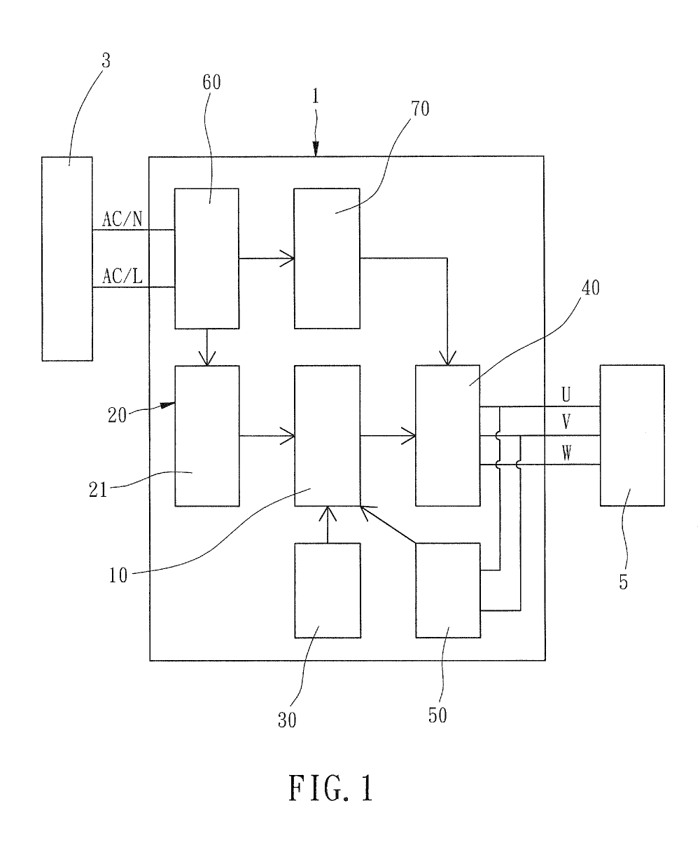

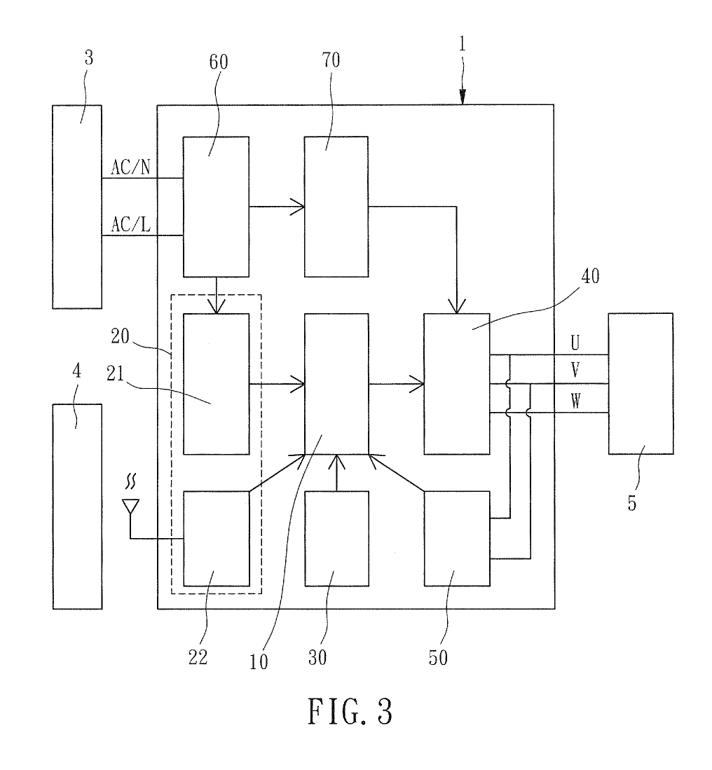

A signal receiving unit 20 connects with the microprocessor 10. The signal receiving unit can be a wired signal receiving unit as shown in FIG. 1, and the driving controller can set by wired signal. The signal receiving unit can be a wireless signal receiving unit as shown in FIG. 3, and the driving controller can set by wireless signal.

A hardware setting unit 30 connects with the microprocessor 10.

A driving circuit 40 connects with the microprocessor 10 and the brushless motor of the ceiling fan.

A feedback circuit 50 connects with the microprocessor 10 and the driving circuit 40. The feedback circuit 50 can detect the amperage or the voltage of the driving circuit 40 and transmits a feedback to the microprocessor 10.

A power input unit 60 connects with a signal receiving unit 20 and a circuit 70 with rectifier and filter function.

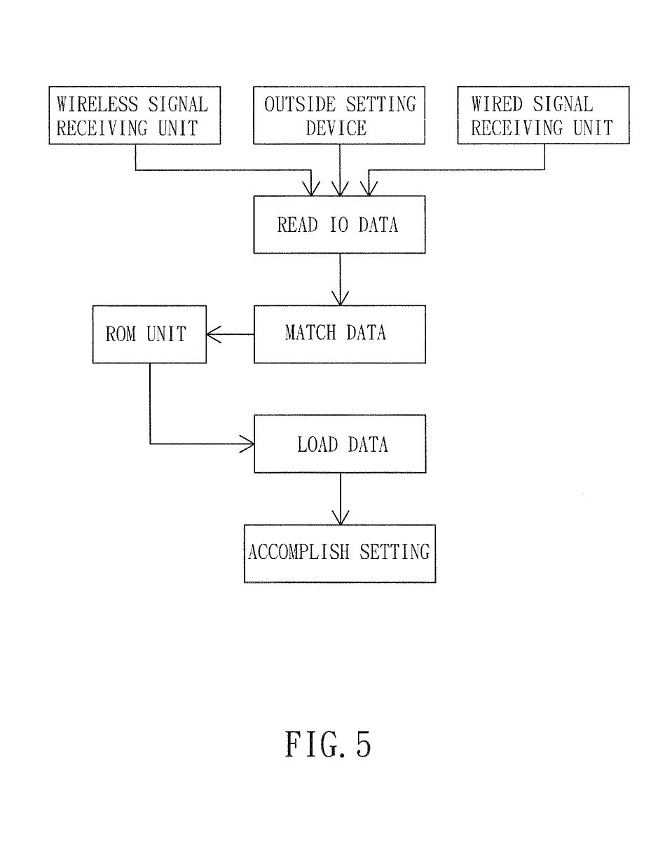

The operation method of the driving controller of present invention is almost the same with prior driving controller. The only difference is the driving controller of present invention needing a setting process before use that inputs the model and the type of the brushless motor into the control programs, as shown in FIG. 5. This setting, which sets by a setting device from outside, can be done by the manufacture in the manufacturing process or can be done by the user. The setting can be done by a wired or wireless way or set the setting device of the driving controller directly. For example like a dip switch.

When the signal receiving unit 20 like a wired signal receiving unit 21 receives a signal, the microprocessor unit 10 reads the signal and calculates the signal by decoding programs, and matches the departure parameter from the departure parameter data inside the ROM units. Then, the microprocessor unit 10 loads the specific departure parameter data into the control programs to complete the setting. Due to the driving controller had the departure parameter, the driving controller, which can drive the brushless motor in correct phase, do not need sensors, detection or locating the armature. The driving controller of present invention causes no shaking or reversing also.

The driving controller 1 of present invention works by the cooperation of the microprocessor and the ROM units, so, basically when the ROM units had sufficient departure parameter data, the driving controller can be used in every type of brushless motor without limitation.

Because that the driving controller needs no sensors, the driving controller 1 of present invention can be split with the brushless motor and connects with the brushless motor with (U,V,W) three power lines only. This is different with the product in present day. The driving controller no longer needs to place adjacent the motor and packs with the brushless motor inside the housing together, so, the machinery structures and the control circuit can be separated. Thus, the driving controller has no maintainable problems. Moreover, the manufacturing process of present invention is more easily due to the driving controller needs no extra lines. The down rod has no problem that needs to allow many lines to pass through it.

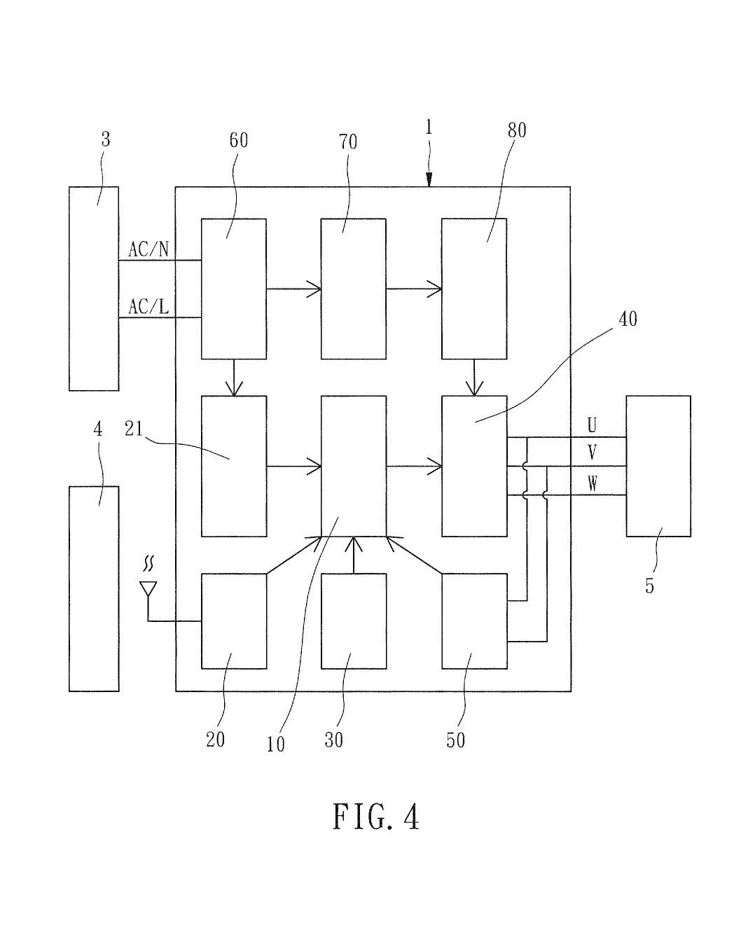

The driving controller can add a power-factor-correction circuit 80, which connects with the driving circuit 40 and a circuit 70 with rectifier and filter function as shown in FIG. 4, to get closer to the requirement of power save and green environment. The power factor can increase over 0.8 (most of the products are under 0.5 now) to improve the efficiency.

Although the invention has been shown and described with respect to preferred embodiments thereof. It should be understood by those skilled in the art that the foregoing and other changes in the form and detail thereof may be made therein without departing from the spirit and scope of the invention.

What is claimed is:

1. A driving controller, which connects with the brushless motor of a ceiling fan with (U,V,W) three power lines and places split with the motor, can drive every type of brushless motor without locating the armature, the driving controller of present invention including:
a microprocessor unit having control programs and ROM units therein, the ROM units saving the departure parameter data of the brushless motor inside, the microprocessor can read a designate departure parameter from the ROM units and loads it into the control programs;
a signal receiving unit connecting with the microprocessor;
a hardware setting unit connecting with the microprocessor;
a driving circuit connecting with the microprocessor and the brushless motor of the ceiling fan;
a feedback circuit connecting with the microprocessor and the driving circuit, the feedback circuit can detect the amperage of the driving circuit and transmits a feedback to the microprocessor;
a power input unit connecting with the signal receiving unit and a circuit with rectifier and filter function.

2. The driving controller as claimed in claim 1, wherein the signal receiving unit is a wired signal receiving unit.

3. The driving controller as claimed in claim 2, wherein the driving controller can be set by wire to load the departure parameter of a motor into the control programs.

4. The driving controller as claimed in claim 1, wherein the signal receiving unit is a wireless signal receiving unit.

5. The driving controller as claimed in claim 4, wherein the driving controller can be set by wireless to load the departure parameter of a motor into the control programs.

6. The driving controller as claimed in claim 1, wherein the driving controller has a power-factor-correction circuit moreover, the power-factor-correction circuit connects with the driving circuit and the circuit with rectifier and filter function, and can increase the power factor over 0.8.

7. A driving controller, which connects with the brushless motor of a ceiling fan with (U,V,W) three power lines and places split with the motor, can drive every type of brushless motor without locating the armature, the driving controller of present invention including:
a microprocessor unit having control programs and ROM units therein, the ROM units saving the departure parameter data of the brushless motor inside, the microprocessor can read a designate departure parameter from the ROM units and loads it into the control programs;
a signal receiving unit connecting with the microprocessor;
a hardware setting unit connecting with the microprocessor;
a driving circuit connecting with the microprocessor and the brushless motor of the ceiling fan;
a feedback circuit connecting with the microprocessor and the driving circuit, the feedback circuit can detect the voltage of the driving circuit and transmits a feedback to the microprocessor;
a power input unit connecting with the signal receiving unit and a circuit with rectifier and filter function.

8. The driving controller as claimed in claim 7, wherein the signal receiving unit is a wired signal receiving unit.

9. The driving controller as claimed in claim 8, wherein the driving controller can be set by wire to load the departure parameter of a motor into the control programs.

10. The driving controller as claimed in claim 7, wherein the signal receiving unit is a wireless signal receiving unit.

11. The driving controller as claimed in claim 10, wherein the driving controller can be set by wireless to load the departure parameter of a motor into the control programs.

12. The driving controller as claimed in claim 7, wherein the driving controller has a power-factor-correction circuit moreover, the power-factor-correction circuit connects with the driving circuit and the circuit with rectifier and filter function, and can increase the power factor over 0.8.
